(19) United States
(12) Patent Application Publication
(10) Pub. No.: US 2011/0218717 A1
(43) Pub. Date: Sep. 8, 2011

(54) METHOD FOR START-UP AND COMPUTER PROGRAM PRODUCT AND APPARATUS

(75) Inventors: Werner Schmitt, Sinzheim (DE); Michael Schuhen, Buehlertal (DE)

(73) Assignee: SCHAEFFLER TECHNOLOGIES GMBH & CO. KG, Herzogenaurach (DE)

(21) Appl. No.: 13/111,214

(22) Filed: May 19, 2011

Related U.S. Application Data
(63) Continuation of application No. PCT/DE2009/001547, filed on Nov. 2, 2009.

(30) Foreign Application Priority Data
Nov. 24, 2008 (DE) 102008058698.6

(51) Int. Cl. F16H 59/00

(52) U.S. Cl. 701/51

(57) ABSTRACT

The resetting of a gear motor compensating parameter ensures that a start-up of a gearbox functions reliably in the vent that components are replaced.

### CROSS-REFERENCE TO RELATED APPLICATIONS

This application claims the benefit of PCT International Patent Application No. PCT/DE2009/001547 filed Nov. 2, 2009 which claims priority from German Patent Application No. 10 2008 058 698.6 filed Nov. 24, 2008 which applications are incorporated herein by reference in their entirety.

### FIELD OF INVENTION

The invention relates to a method with features according to the preamble of patent claim 1 and to a device with the features according to the preamble of patent claim 13.

### BACKGROUND OF THE INVENTION

DE 10 2005 000 888 A1 discloses a method for performing a teaching procedure upon a transmission of a vehicle, in particular a parallel shifting transmission in which parameters are taught to a transmission actuation device and a clutch actuation device. The teaching procedure is performed on a test stand before final assembly of the transmission with the clutch attached.

A method for compensating track changes are proposed in DE 103 16 436 A1 for a transmission control of an automated transmission of a vehicle, wherein track changes are detected and compensated.

Control devices monitor input- and output values and internal values of the control device. In particular when controlling electric motors like e.g. selecting motors or shifting motors in a transmission actuation device for shifting gears or in a clutch actuation, it is being monitored, whether the control yields the desired effect.

When a voltage is applied to the respective electric motor through the control device end stage, wherein the voltage was previously computed through the functional software, this yields a respective reaction in the form of a position change of the electric motor. The positions are determined in an incremental manner.

Based on component tolerances or different levels of friction, deviations from a nominal system can occur which becomes apparent in that the movement speed of the respective electric motor or also the forces of the respective electric motor do not correspond to the nominal system any more.

In order to compensate the deviations adaptive parameters, designated compensation parameters in this context are recited which are being adapted over the run time or service life and which correct or remove deviations from the nominal system. This shall assure that e.g. a gear change always feels the same for a driver, though the boundary conditions may change over time.

The compensation parameter which corresponds to the actuation amplification eventually influences the voltage put out by the end stage in the sense of an amplification or reduction of the voltage that is being put out compared to the non compensated value.

The compensation parameter is specifically determined for each connected drive like e.g. an electric motor. The adaptation is performed over the run time. Thus, the compensation parameter is slightly adapted for each shifting process, however, it is not adapted for start-up processes. Thus typically the compensation parameter is recalculated after each gear change and taken over in a filtered manner. The compensation parameter is defined by a maximum value and a minimum value. At the point in time of delivery or after production the compensation parameter is set to a default value which does not provide corrections for the output voltage. This way the first movements of the electric motors are performed without correction.

An initial startup for the purposes of this document is the first startup after the system has been produced.

A restart for the purposes of this document is the startup after exchanging or repairing the system, thus of the respective drive e.g. when exchanging the transmission or particular transmission components or exchanging the actuation device or the electric motor of the actuation device or replacing the control device with or without clutch- or transmission actuation device.

A new startup is also a startup performed externally through a test device, e.g. a diagnostic test device in a shop or in the vehicle or transmission production plant. This can also be performed without performing an exchange or a repair.

The teaching process is performed after a startup of this type.

Adaptive parameters in the context of this document are all parameters which are taught initially in the context of adaption strategies, e.g. during startup and which are subsequently changed. Changing the parameter is thus performed through the adaptation during the run time. Examples for adaptive parameters are compensation parameters. When a new startup is performed e.g. after replacing components, the adaptive parameters according to the present invention are reset to the initial values at the initial production which are also designated as initialization- or default values.

An initial startup is initiated after an initial actuation of an ignition of a vehicle through actuation of predetermined actuation elements in a predetermined sequence, e.g. a brake pedal or a gear shifter. An initial startup, however, can also be performed through using a shops tester or a test stand.

During a first startup after initial production or after the delivery date the teaching process of the connected transmission activator of the transmission is performed with the default values for the compensation parameter, thus without correction of the initial voltage. The results of the teaching process of initial startup directly after the delivery date like e.g. gear end positions, synchronization thresholds, path widths or reference point can significantly deviate from the results which are determined upon a repeat startup with already adapted values as this can be the case for a repeat startup during service, typically in a shop. This can lead so far that a repeat startup is not possible any more since the position values are now determined based on revised voltage values which are outside of the permissible transmission tolerances. The causes can be changed boundary conditions like e.g. through exchanging the transmission or particular transmission components or changing the actuation device or the electric motor of the actuation device or changing the control device with or without clutch or transmission actuation device.

Position changes can be detected through incremental path measurement and can be recomputed to absolute positions in the software. Thus, typically knowledge of the reference point is required which is taught during startup.

After a successful initial startup an existing error memory entry with respect to the system that is being started up or with respect to components of the system that is being started up, wherein the error memory entry refers before a first startup to an initial startup that has not been performed, is deleted.

Any subsequent startup is a repeat startup which can be detected from the error memory entry not being provided any more, wherein the error memory entry will have referred to an initial startup that has not been performed yet.

### BRIEF SUMMARY OF THE INVENTION

Thus it is the object of the invention to remove deficiencies. An option shall be described to successfully perform the repeat startup in spite of the already adapted compensation parameters.

This object is achieved through a method with the features according to claim 1, a computer program product according to claim 12 and a device with the features according to claim 13.

According to the invention the method for determining a value of an adaptive parameter during a repeat startup of an adaptable system provides that for a repeat startup of the system the repeat startup is performed with the value of the adaptive parameter as it is provided for the initial startup of the system. The repeat startup of the system thus is not performed with an already adapted value for the adaptive parameter, but with the value for the adaptive parameter as it is provided for the initial startup of the system.

A system of this type is preferably a drive of an actuation device of an automated transmission or an automated clutch.

In a preferred embodiment an adaptive value is a compensation parameter of the system.

In another embodiment a repeat startup of the system is performed with the initial default value of the adaptive parameter under predetermined conditions.

In a preferred embodiment a predetermined condition of this type is a lack of an indication for an initial startup that has not been performed yet.

The initial startup of the system is performed when an indication is provided that an initial startup has not been performed yet.

In a preferred embodiment an indication of an initial startup that has not yet been performed is stored in the error memory.

In another preferred embodiment the indication for an initial startup that has not yet been performed is stored in a permanent memory, whose memory content is independent from the power supply and is not lost when the power supply cuts out.

Alternatively or cumulatively boundary conditions of this type are an exchange or a repair of a component of the system or of the automated transmission or of the automated clutch.

The component of the automated transmission or of the automated clutch is preferably a particular transmission component or clutch component or a transmission actuation device or a clutch actuation device or a drive of the actuation device or an electric motor of the actuation device or a control device of the clutch- or transmission actuation device or a control device including a transmission- or clutch actuation device.

In an alternative embodiment the repeat startup of the system is performed with the initial default value of the adaptive parameter when this is caused through a diagnostic service.

In another embodiment the diagnostic service is performed with a piece of test equipment, e.g. a diagnostic tester.

According to the invention a computer program product with a computer program is also proposed which includes software tools for performing the methods recited supra when the computer program is executed on the computer. A computer of this type can be part of the control device for controlling the system.

According to the invention also a device for determining a value of an adaptive parameter upon repeat startup of an adaptable system in a drive train for performing one of the methods recited supra is proposed. Thus, the device includes a control device. Upon repeat startup of the system the control device is configured to cause the repeat startup with the default value of the adaptive parameter 20 as it is provided for initial startup of the system, wherein the default value is configured to be stored so that the control device 164,174,180 can access the default value. Thus the control device is configured to cause that the repeat startup is not performed with a value of the adaptive parameter that is already adapted.

When a repeat startup is performed with the changed boundary conditions, e.g. due to exchange or replacement of the transmission or the transmission actuation device or an electric motor the repeat startup should not be performed with the compensation parameters that have already been adapted, but with the initial default values as they were provided for initial startup directly after the delivery date.

According to the invention the compensation parameters, more generally speaking the adaptation parameters are reset to default through the functional software of the control device when the startup of the transmission or of the clutch is initiated. The repeat startup performed with the default parameter provides that transmissions whose parameters like e.g. gear end position or synchronization thresholds are within permissible tolerances can also be successfully learned during the subsequent learning process.

The default values for the compensation parameters are stored in a storage portion which can be accessed by the software.

For a new hardware, e.g. when replacing the hardware also when only components are concerned it is provided to discard the adapted values and to use the default values of the compensation parameters. Thus, it shall be provided that a repeat startup is always possible when the particular hardware components are within their tolerance limits. Resetting already adapted compensation parameters shall thus be performed according to the invention automatically by the software before each repeat startup.

According to the invention it is thus alternatively provided that resetting the compensation parameters can be performed through a diagnostic service also through a connected piece of test equipment like e.g. a shop tester.

### BRIEF DESCRIPTION OF THE SEVERAL VIEWS OF THE DRAWING

Other advantages and advantageous embodiments of the invention are described with reference to drawing figures, wherein:

FIG. 1 schematically illustrates the method according to the invention; and

FIG. 2 schematically illustrates the interacting components.

### DETAILED DESCRIPTION OF THE INVENTION

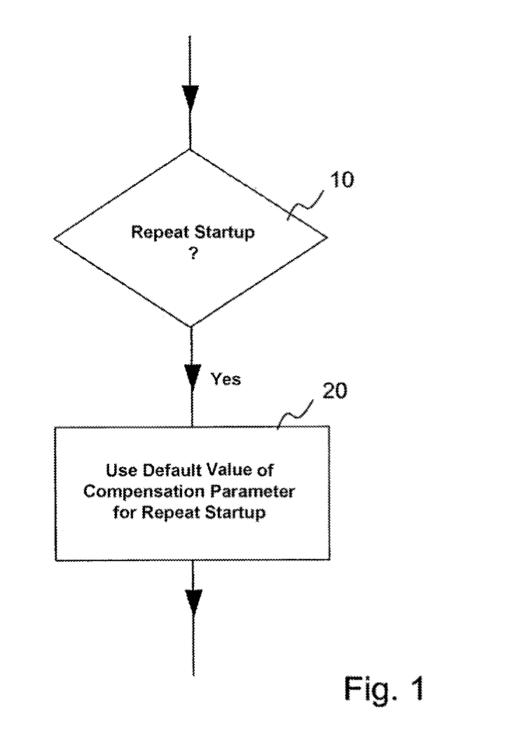

FIG. 1 schematically illustrates the method according to the invention. The interrogation step 10 checks whether a repeat startup, thus no initial startup of an automated clutch or an automated transmission is performed. When this is the case, it is provided according to the invention to use the default value of the respective compensation parameters of the drive which are provided for the initial startup of the automated transmission or of the automated clutch after initial production and which are stored in a memory for the instant repeat startup.

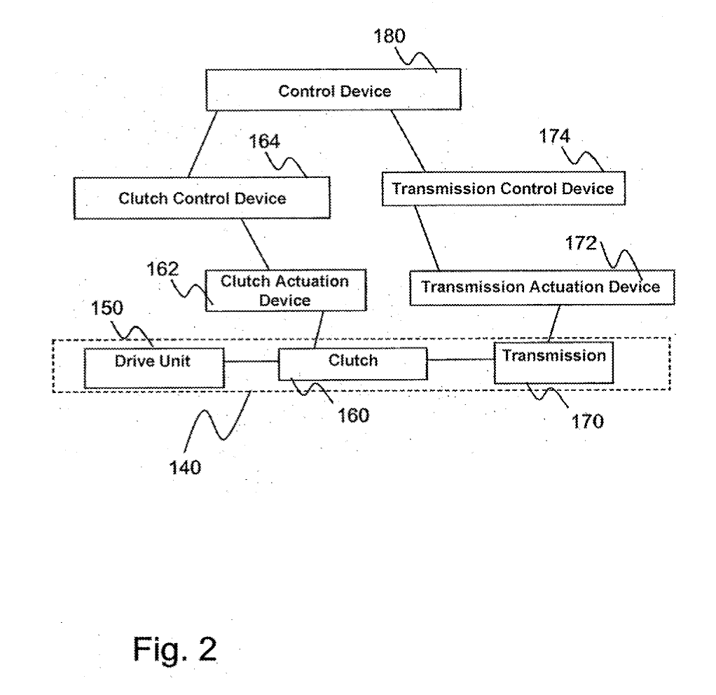

FIG. 2 schematically illustrates the interacting components of a device which are configured for performing the method recited supra.

The device is used for determining the suitable compensation parameters when activating the automated clutch 160 and/or the automated transmission 170 for a repeat startup.

A transmission of this type includes a plurality of transmission stages. Furthermore an automated clutch 160 is arranged in the drive train of the motor vehicle between a drive unit 150 and the transmission 170. The clutch 160 is configured to be controlled through a clutch actuation device 162 configured as clutch actuation means of the clutch 160 through a clutch control device 164. The transmission stages in the transmission 170 are shiftable as actuation devices of the transmission 170 and the transmission actuation device 172 is configured to be controlled by a transmission control device 174.

A control device 164, 174, 180, depending on the application this can be the transmission control device 174 or the clutch control device 164 or a superimposed or juxtaposed control device or an additional control device 180, can be determine whether a repeat startup is provided. When this is the case, it is provided according to the invention to set the respective compensation parameters of the drive for the instant repeat startup to the compensation parameters that are configured to be stored in a memory in the control device 167, 174, 180 to predeterminable default values as they are provided for the initial startup of the transmission 160 after initial production.

The three control devices 164, 174, 180 which can be configured as three discrete control devices due to their different functions can certainly be provided distributed to one control device or also to two control devices.

### REFERENCE NUMERALS AND DESIGNATIONS

Interrogation step
20 Movement step
140 Drive train
150 drive unit
160 clutch
162 clutch actuation device
164 clutch control device
170 transmission
172 transmission actuation device
174 transmission control device
180 control device

What we claim is:

1. A method for determining a value for an adaptive parameter upon repeat startup of an adaptable system, wherein the system is a drive of an actuation device of an automated transmission or of an automated clutch, wherein upon repeat startup (10) of the system, the repeat startup is performed with a value for the adaptive parameter (20) as it is provided for an initial startup of the system.

2. The method according to claim 1, wherein the adaptive parameter is a compensation parameter of the system.

3. The method according claim 1, wherein the repeat startup of the system is performed with the original default value of the adaptive parameter under predetermined conditions.

4. The method according claim 1, wherein predetermined conditions include a lack of an indication that an initial startup has not been performed.

5. The method according to claim 1, wherein the initial startup of the system is performed when an indication is provided that an initial startup has not been performed.

6. The method according to claim 5, wherein an indication is stored in an error memory that indicates that an initial startup has not been performed.

7. A method according to claim 5, wherein an indication is stored in a permanent memory that indicates that an initial startup has not been performed yet.

8. The method according to claim 3, wherein the predetermined conditions include a replacement or a repair of a component of the automated transmission or of the automated clutch.

9. The method according to claim 3, wherein the components of the automated transmission or of the automated clutch are particular transmission components or clutch components or a transmission actuation device or a clutch actuation device or a drive for an actuation device or an electric motor for an actuation device or a control device for the clutch- or transmission actuation device or a control device including a transmission- or clutch actuation device.

10. The method according to claim 1, wherein the repeat startup of the system is caused with an original default value of the adaptive parameter when this is caused through a diagnostic service.

11. The method according to claim 10, wherein the diagnostic service is a piece of test equipment.

12. A computer program product comprising a computer program which includes software tools for performing the method according to claim 1 when the computer program is executed on a computer.

13. A device for determining a value for an adaptive parameter upon repeat startup of an adaptable system in a drive train (140) through a control device, wherein upon repeat startup of the system, the control device (164, 174, 180) is configured to cause the repeat startup with a default value of the adaptive parameter (20) as it is provided for initial startup of the system, wherein the default value for the control device (164, 174, 180) is configured to be storable in an accessible manner.
